(19) United States
(12) Patent Application Publication
(10) Pub. No.: US 2019/0280856 A1
(43) Pub. Date: Sep. 12, 2019

(54) APPLIED CRYPTOGRAPHIC IP MANAGEMENT METHOD AND SYSTEM

(71) Applicants: Siah Chong CHEONG, Singapore (SG); Sain Keat CHUANG, Singapore (SG); Tralvex @ Rex Yeap YEAP, Singapore (SG); Kai Tien LING, Singapore (SG)

(72) Inventors: Tralvex @ Rex Yeap YEAP, Singapore (SG); Kai Tien LING, Singapore (SG)

(21) Appl. No.: 16/302,243

(22) PCT Filed: May 19, 2016
(86) PCT No.: PCT/SG2016/050237

§ 371 Date: Nov. 16, 2018

(51) Int. Cl. H04L 9/06; H04L 9/32; G06F 21/60; G06Q 50/18

(52) U.S. Cl. CPC H04L 9/0643; H04L 9/3239; G06F 21/602; G06Q 2220/00; H04L 2209/38; G06F 2221/2107; G06Q 50/184

(57) ABSTRACT

Described herein is a blockchain method and system for applied cryptographic IP management. This method and system for may include generating an IP datablock from an IP file. The IP datablock is preferably for use in updating an IP blockchain to thereby register the IP file and to enable verification of IP thereagainst.

### TECHNICAL FIELD

This invention relates generally to an applied cryptographic Intellectual Property (IP) management method and system (also referable to as an IP blockchain method and system).

### BACKGROUND

Previous Intellectual Property (IP) management system are centralized in nature and involved the storing of the entire IP asset in its database for subsequent matching and verification when a matching IP is presented. Such centralized databases require huge and ever-increasing storage requirements. For example, an IP that is 1 Petabyte in file size will require a large centralized database to accommodate. Further, such IP management systems are exposed to being easily compromised. A hacker of the IP management system could modify the IP database to insert additional IP Asset, thereby compromising the validity of the IP management system. There is therefore a need for a method and system for addressing the foregoing problems.

### SUMMARY

In accordance with a first aspect of the invention, there is disclosed an Intellectual Property (IP) blockchain method comprising processing a IP file with a hash function to obtain an IP digest by a platform system, determining a previous block digest from a previous IP blockchain by the platform system, and appending the previous block digest and IP reference dataset to the IP digest to obtain an IP datablock by the platform system, the IP reference dataset being associated with the IP file. Wherein the previous IP blockchain is updatable with the obtained IP datablock to obtain an updated IP blockchain.

In accordance with a second aspect of the invention, there is disclosed a machine-readable medium having stored therein a plurality of programming instructions, which when executed, the instructions cause the machine to process a IP file with a hash function to obtain an IP digest, determine a previous block digest from a previous IP blockchain, and append the previous block digest and IP reference dataset to the IP digest to obtain an IP datablock, the IP reference dataset being associated with the IP file. Wherein the previous IP blockchain is updatable with the obtained IP datablock to obtain an updated IP blockchain.

In accordance with a third aspect of the invention, there is disclosed an Intellectual Property (IP) blockchain system comprising a first database module for providing an IP file to be processed, a second database module for providing auxiliary information dataset associated with the IP file, the auxiliary information dataset comprising identity of at least one owner of the IP file and title of the IP file, and a third database module for providing a previous IP blockchain. The IP blockchain system further comprises a controller module in data communication with the first database module, the second database module and a third database module. The controller module is for processing the IP file with a hash function to obtain an IP digest, determining a previous block digest from the previous IP blockchain, appending the previous block digest and the IP reference dataset to the IP digest to obtain an IP datablock, and updating the previous IP blockchain of the first database module with the obtained IP datablock. The IP reference dataset comprises at least one of counter value indicative of ordinal position of the IP datablock amongst a plurality of datablocks constituting the previous IP blockchain, version number of at least one of protocol and software employed by the platform system for performing the IP blockchain method, at least one of date and time of creation of the IP datablock, indication of storage of the IP file in an IP repository, the identity of at least one owner of the IP file, and the title of the IP file.

### BRIEF DESCRIPTION OF THE DRAWINGS

FIG. 1 shows a system block diagram of an Intellectual Property (IP) blockchain system, also referable to as an applied cryptographic IP management system, in accordance with an aspect of the invention;

FIG. 2 shows a process flow of an IP registration process of an IP blockchain method, also referable to as an applied cryptographic IP management method, according to an aspect of the invention for being implemented by the IP blockchain system of FIG. 1;

FIG. 3 shows a process flow of obtaining and validating an IP datablock within the IP registration process of FIG. 2;

FIG. 4 shows a process flow of a first IP verification method 200, also known as an IP verification (Type 1) process, of the IP blockchain method implemented by the IP blockchain system of FIG. 1; and

FIG. 5 shows a process flow of a second IP verification method 200, also known as an IP verification (Type 2) process, of the IP blockchain method implemented by the IP blockchain system of FIG. 1.

### DETAILED DESCRIPTION

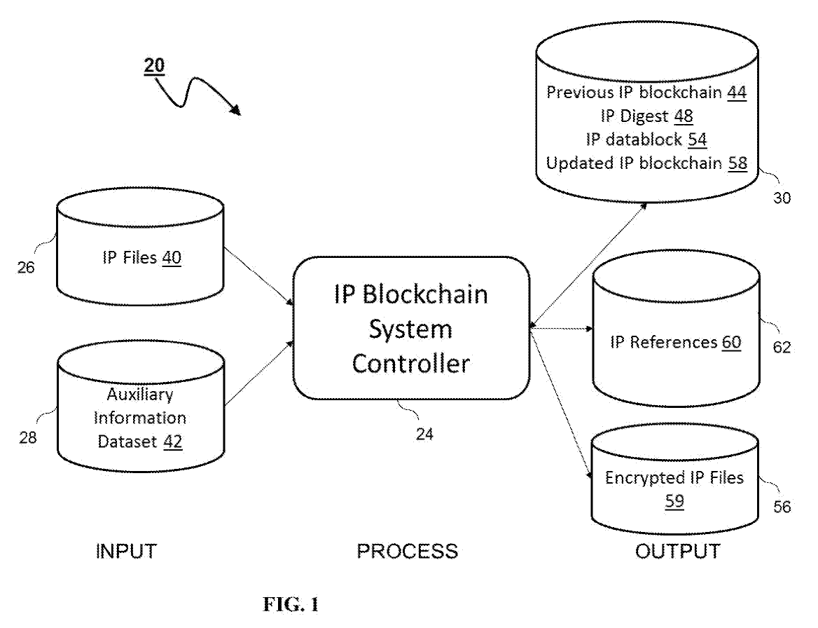

An exemplary embodiment of the present invention, an applied cryptographic Intellectual Property (IP) management system 20 for implementing an applied cryptographic IP management method 100 is described hereinafter with reference to FIGS. 1 to 5. The applied cryptographic IP management system 20 and the applied cryptographic IP management method 100 are also referable to and known, respectively, as an IP blockchain system 20 and an IP blockchain method 100.

Implementations of the present disclosure are generally directed to the IP blockchain method 100 and the associated IP blockchain system 20 to provide a comprehensive platform system to facilitate delivery of services in, but not limited, business-to-business (B2B), business-to-consumer (B2C), consumer-to-consumer (C2C), business-to-government (B2G) and government-to-business (G2C) arrangements. The B2B applies also to individuals requiring operating in a business framework. The services provided can be adapted through a choice of B2B gateway services. The services can be aggregated by and channeled through third-parties.

Implementations of the service management method 100 support diversified business possibilities and service delivery between businesses facilitated by best-of-breed platform of the service management system 20. The service management method sets the stage for the next service-oriented revolution, referred variously as service ecosystems, future business value networks, and other forms of hubs and communities, underpinned by an Internet-scale infrastructure, to provide a level playing field for supply and demand of IP registration and verification services on over the Internet across a multitude of devices and computing systems.

An exemplary system architecture of the IP blockchain system 20 that can execute implementations of the present disclosure, can include one or more of a user computing device associated with a user and a IP blockchain system controller 24 (controller module 24). As shown in FIG. 1, the IP blockchain system 20 further comprises a first database module 26, a second database module 28 and a third database module 30 in data communication with the controller module 24. The user computing device can communicate with the controller module 24 over a network. In some implementations, the IP blockchain system 20 may represent a client/server system supporting multiple computer systems (e.g., the controller module 24) including one or more clients (e.g., the user computing device) that are connectively coupled for communication with one another over the network.

The user computing device can represent various forms of processing devices including, but not limited to, a desktop computer, a laptop computer, a handheld computer, a personal digital assistant (PDA), a smartphone, a smart tablet, a cellular telephone, a network appliance, a camera, a smart phone, an enhanced general packet radio service (EGPRS) mobile phone, a media player, a navigation device, an email device, a game console, or a combination of any two or more of these data processing devices or other data processing devices. The user computing device may access application software on one or more of the control computer systems 26.

The controller module 24 can represent various forms of server systems including, but not limited to a web server, an application server, a proxy server, a network server, or a server farm. For example, one or more of the servers can be an application server that executes software accessed by the user computing device. In some implementations, a user can invoke applications available on one or more of the servers in a web browser or a mobile application running on a client (e.g., user computing device). Each application can individually access data from one or more repository resources (e.g., the first database module 26 and the second database module 28).

The network can be a large computer network, such as a local area network (LAN), wide area network (WAN), the Internet, a cellular network, or a combination thereof connecting any number of mobile clients, fixed clients, and/or servers. In some implementations, each client (e.g., user computing device) can communicate with one or more of the control computer systems 26 via a virtual private network (VPN), Secure Shell (SSH) tunnel, or other secure network connection. In some implementations, the network can include the Internet, a wireless service network and may include the Public Switched Telephone Network (PSTN). In other implementations, the network may include a corporate network (e.g., an intranet) and one or more wireless access points.

The user computing device can establish its own session with the controller module 24. Each session can involve two-way information exchange between the control computer systems 26 and the user computing device. For example, a Hypertext Transfer Protocol (HTTP) session can allow the association of information with individual users. A session can be stateful session, in which at least one of the communicating parts (e.g., the controller module 24 or the user computing device) stores information about the session history in order to be able to communicate. Alternatively, stateless communication during a stateless session includes independent requests with associated responses.

In an exemplary embodiment of the IP blockchain method 100, an IP file 40 and auxiliary information dataset 42 are provided to the IP blockchain system 20. The IP file 40 and the auxiliary information dataset 42 are preferably captured or stored on the first database module 26 and the second database module 28 respective, and may be uploaded thereto via the user computing device. The IP file 40 and the auxiliary information dataset 42 are preferably inter-associated, for example, by tagging in an implement that that the first database module 26 and the second database module 28 may contain a plurality of the IP file 40 and a plurality of the auxiliary information dataset 42 for processing by the controller module 24. A previous IP blockchain 44 is provided by the third database module 30 and could be a product of a previous iteration or execution of the IP blockchain method 100.

### IP Registration

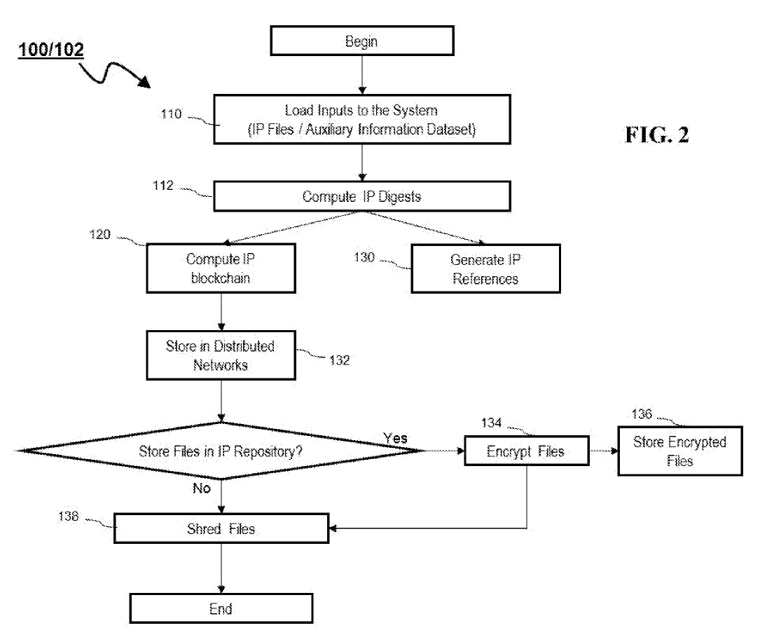

Referring to FIG. 2, the IP blockchain method 100 comprises an IP registration process 102 for processing and registering the IP file 40 with the IP blockchain system 20. In a step 110 of the registration process 102, the IP file 40 and the associated auxiliary information dataset 42 to be processed are obtained from the first database module 26 and the second database module 28 respectively. Preferably, the IP file 40 contains matter relating to at least one of patents, registered designs, trademarks, copyrights, trade secrets, know-how, chemical compositions and recipes, plant breed dataset, electronic masks, data listing, images, operating manuals, legal documentation, and the like registered IP, registrable IP and documented intellectual assets.

The IP file 40 and the associated auxiliary information dataset 42 to be processed are obtained by being loaded into the memory storage medium of the controller module 24. The controller module 24 comprises a processor, a processor-readable storage medium containing one or more programming instructions relating to the IP blockchain method 100. The programming instructions are installed in a computing program and also a computing program product. It is submitted that the computing program comprise of program code means for performing the steps of the IP blockchain method 100. It is further submitted that the computing program product comprise of program code means stored on a computer readable medium for performing all the steps of the IP blockchain method 100.

Next, in a step 112, the IP file 40 is processed with a hash function to obtain an IP digest 48. The IP digest 48 can be computed using a suitable hash function such as but not limited to SHA1, SHA256, SHA3, BLAKE and BCRYPT. An example of a source code that compute a SHA256 digest is as follow:

| | | |
|---|---|---|
| /* | Compute SHA256 digest source code | */ |

#define op_ror(val, bt) (((val) >> (bt)) | ((val) << (32 − (bt))))
#define op_shr(val, bt) ((val) >> (bt))
static const uint32_t Kv[64] = { 0x428a2f98, 0x71374491, 0xb5c0fbcf, 0xe9b5dba5, 0x3956c25b,

| | | | | | | |
|---|---|---|---|---|---|---|
| 0x59f111f1, | 0x923f82a4, | 0xab1c5ed5, | 0xd807aa98, | 0x12835b01, | 0x243185be, | 0x550c7dc3, |
| 0x72be5d74, | 0x80deb1fe, | 0x9bdc06a7, | 0xc19bf174, | 0xe49b69c1, | 0xefbe4786, | 0x0fc19dc6, |
| 0x240ca1cc, | 0x2de92c6f, | 0x4a7484aa, | 0x5cb0a9dc, | 0x76f988da, | 0x983e5152, | 0xa831c66d, |
| 0xb00327c8, | 0xbf597fc7, | 0xc6e00bf3, | 0xd5a79147, | 0x06ca6351, | 0x14292967, | 0x27b70a85, |
| 0x2e1b2138, | 0x4d2c6dfc, | 0x53380d13, | 0x650a7354, | 0x766a0abb, | 0x81c2c92e, | 0x92722c85, |
| 0xa2bfe8a1, | 0xa81a664b, | 0xc24b8b70, | 0xc76c51a3, | 0xd192e819, | 0xd6990624, | 0xf40e3585, |
| 0x106aa070, | 0x19a4c116, | 0x1e376c08, | 0x2748774c, | 0x34b0bcb5, | 0x391c0cb3, | 0x4ed8aa4a, |
| 0x5b9cca4f, | 0x682e6ff3, | 0x748f82ee, | 0x78a5636f, | 0x84c87814, | 0x8cc70208, | 0x90befffa, |

0xa4506ceb, 0xbef9a3f7, 0xc6717gf2 };
static void SHA256_Op(SHA256_CS* cs) {

uint32_t W[64]; uint32_t A, B, C, D, E, F, G, H; uint8_t* p = cs−>buffer; int t;
for(t = 0; t < 16; ++t) {

uint32_t tmpVal = *p++ << 24;
tmpVal |= *p++ << 16; tmpVal |= *p++ << 8; tmpVal |= *p++;
W[t] = tmpVal;

}
for(; t < 64; t++) {

uint32_t s0 = op_ror(W[t−15], 7) \hat{ } op_ror(W[t−15], 18) \hat{ } op_shr(W[t−15], 3);
uint32_t s1 = op_ror(W[t−2], 17) \hat{ } op_ror(W[t−2], 19) \hat{ } op_shr(W[t−2], 10);
W[t] = W[t−16] + s0 + W[t−7] + s1;

}
A = cs−>st[0]; B = cs−>st[1]; C = cs−>st[2]; D = cs−>st[3];
E = cs−>st[4]; F = cs−>st[5]; G = cs−>st[6]; H = cs−>st[7];
for(t = 0; t < 64; t++) {

uint32_t sx0 = op_ror(A, 2) \hat{ } op_ror(A, 13) \hat{ } op_ror(A, 22);
uint32_t mj = (A & B) \hat{ } (A & C) \hat{ } (B & C);
uint32_t tx2 = sx0 + mj;
uint32_t sx1 = op_ror(E, 6) \hat{ } op_ror(E, 11) \hat{ } op_ror(E, 25);
uint32_t cc = (E & F) \hat{ } ((~E) & G);
uint32_t tx1 = H + sx1 + cc + Kv[t] + W[t];
H = G; G = F; F = E; E = D + tx1; D = C; C = B; B = A; A = tx1 + tx2;

}
cs−>st[0] += A; cs−>st[1] += B; cs−>st[2] += C; cs−>st[3] += D;
cs−>st[4] += E; cs−>st[5] += F; cs−>st[6] += G; cs−>st[7] += H;

}
static const HASH_V SHA256_V = {

SHA256_ref,
SHA256,
SHA256_h,
SHA256_SZ

};
void SHA256_ref(SHA256_CS* cs, const void* data, int len) {

int i = (int) (cs−>count & 63);
const uint8_t* p = (const uint8_t*)data;
cs−>count += len;
while (len−−) {

cs−>buf[i++] = *p++;
if (i == 64) {

SHA256_Op(cs); i = 0;

}

}

}
const uint8_t* SHA256(SHA256_CS* cs) {

uint8_t *p = cs−>buffer;
uint64_t cnt = cs−>ct * 8;
int i;
SHA256_ref(cs, (uint8_t*)“\x80”, 1);
while ((cs−>ct & 63) != 56) {

SHA256_ref(cs, (uint8_t*)“\0”, 1);

}
for (i = 0; i < 8; ++i) {

uint8_t tmpVal = (uint8_t) (cnt >> ((7 − i) * 8)); SHA256_ref(cs, &tmpVal, 1);

}
for (i = 0; i < 8; i++) {

uint32_t tmpVal = cs−>st[i]; *p++ = tmpVal >> 24; *p++ = tmpVal >> 16; *p++ =

tmpVal >> 8; *p++ = tmpVal >> 0;

}
return cs−>buffer;

}
const uint8_t* SHA256_h(const void* data, int len, uint8_t* dgst) {

SHA256_CS cs;
cs−>f = &SHA256_V;
cs−>st[0] = 0x6a09e667; cs−>st[1] = 0xbb67ae85; cs−>st[2] = 0x3c6ef372; cs−>st[3] =

0xa54ff53a;

cs−>st[4] = 0x510e527f; cs−>st[5] = 0x9b05688c; cs−>st[6] = 0x1f83d9ab; cs−>st[7] =

0x5be0cd19; cs−>ct = 0;
}

| | | |
|---|---|---|
| /* | End of Digest source code | */ |

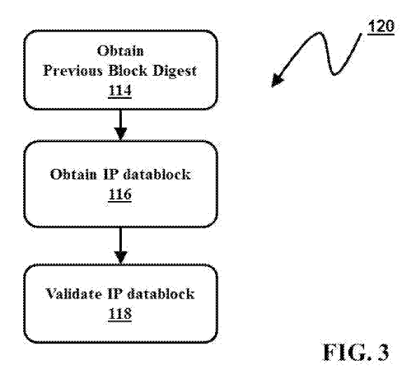

Referring to FIG. 3, a previous block digest is determined from the previous IP blockchain 44 of the third database module 30 in a step 114 performed prior to, in tandem with or subsequent to the step 112. The previous block digest and an IP reference dataset is then appended to the IP digest 48 to obtain an IP datablock 54 in a step 116. An IP blockchain is made up of a concatenated list of validated blocks or datablocks, each linking to its previous block all the way to the first block or genesis block. Hence, any modification of the IP blockchain can be easily detected due to the change in its digest when computed at a later stage. In a step 118, the IP datablock 54 is validated against a predefined data structure prior to updating the previous IP blockchain 44 with the obtained IP datablock 54. An exemplary structure for the IP datablock 54 is as follow:

The Structure of a Block (700-byte)

4 bytes: Reserved
680 bytes: Block Header
16 bytes: Transaction Counter

Block Header

4 bytes: Version number to track software/protocol upgrades
64 bytes: Digest of the previous block
250 bytes: Owner(s) of an IP file
250 bytes: Title of the IP file
64 bytes: Digest of the IP file
4 bytes: Creation Date of this block
4 bytes: Creation Time of this block
1 byte: Denotes whether the IP file stored in an IP database
39 bytes: Reserved

The IP reference dataset is generated at the point of creation of the IP datablock 54 and comprises at least a portion of the auxiliary information dataset 42. As shown in the exemplary structure of the IP datablock 54, the IP reference dataset comprising at least one of counter value indicative of ordinal position of the IP datablock 54 amongst a plurality of datablocks constituting the previous IP blockchain 44, version number of at least one of protocol and software employed by the IP blockchain system 20, or platform system, for performing the IP blockchain method 100, identity of at least one owner of the IP file 40, title of the IP file 40, at least one of date and time of creation of the IP datablock 54, and indication of storage of the IP file 40 in an IP repository 56. This demonstrates a user's ability to obtain a time stamp (i.e. the date and time of creation of the IP datablock 54) without need to reveal the actual IP (i.e. the content of the IP file 40). The IP file 40 need only to be processed by the IP blockchain system 20 when employing the IP blockchain method 100.

Referring to FIG. 1 and FIG. 2, in a step 120, the previous IP blockchain 44 is updated with the IP datablock 54 obtained in the step 116 to obtain an updated IP blockchain 58. For the avoidance of doubt, the updated IP blockchain 58 of a previous iteration of the IP blockchain method 100 will become the previous IP blockchain 44 of the next iteration of the IP blockchain method 100 for processing a different one of the IP file 40.

In a step 130, an IP reference 60 is generated for storing in an IP References database module 62. The input fields are owner(s) first name, owner(s) last name, title of the IP file 40, the previous block digest of the IP file 40 and the date of creation as shown and the output can be in any of the bibliographic reference format such as the Chicago Manual of Style, Harvard Citation Style, American Psychological Association style among others. Two examples are as follow:

IP Reference Example 1 (Structure):
Lastname Firstname, Lastname Firstname. Year. “Title of IP.” IP blockchain, Digest, YYYY-MM-
DD.
IP Reference Example 2 (An IP by John Lim):
Lim John, Tan David. 2016. “Method and System for Deep Learning Multi-Agent Soccer
Robotics.”, IP blockchain, E3456FE98DEFB1733BB2E59FF9E9E31A98E8B7ED53434F3DF65CD6507
36DB5FE, 2016-04-29.

For clarity, although the IP reference 60 and the previous IP datablock 54 may contain the same or similar content, a substantial portion of the IP reference 60 is presented in text whereas the entirety or a substantial portion of the IP datablock 54 is presented in machine code, for example, as binary code.

Similar to a Bitcoin blockchain, the updated IP blockchain 58 can also be distributed in peer to peer distributed databases and networks such as BitTorrent through the creation of a torrent file for subsequent distribution over the networks. Hence, in a step 132, a ledger is updated with at least one of the IP datablock 54 and the updated IP blockchain 58 in response to the previous IP blockchain 44 being updated, and distributed to a plurality of distributed databases in data communication with the IP blockchain system 20.

A user of the IP blockchain system 20 seeking to register the IP file 40 therewith may be prompted to store the IP file 40 with the IP repository 56 of the IP blockchain system 20. If the user decides to store the IP file 40 on the IP repository 56, the IP file 40 is encrypted to obtain an encrypted IP file 59 in a step 134 prior to storing the encrypted IP file 59 on the IP repository 56 in a step 136. Encryption method employed for encrypting the IP file 40 is at least one of private key cryptography, public key cryptography or quantum cryptography.

However, if the user chooses not to store the IP file 40 with the IP repository 56, the IP file 40 will be digitally shredded in a step 138. Algorithms employable for digitally shredding the IP file 40 may include existing methods such as US DOD 5220.22-M (8-306/E, C & E), Schneider's method, Gutmann's method, German VSITR, US Air Force 5020, or Russian GOST P50739-95.

As above presented, the IP blockchain method 100 and the IP blockchain system 20 does not require the full IP Asset to be stored within an IP database. Further, the IP database can be decentralized and publicly available contributed by the fact that use of blockchain technology enables that benefit that if any part of the IP blockchain is compromised, it will be detected.

### IP Verification

Consequently, IP, or IP files, that have been registered using the IP blockchain method 100 within the IP blockchain, specifically the updated IP blockchain 58, can also be verified. While there are many different verification methods of each registered IP in the IP blockchain, two exemplary methods, are disclosed hereinafter.

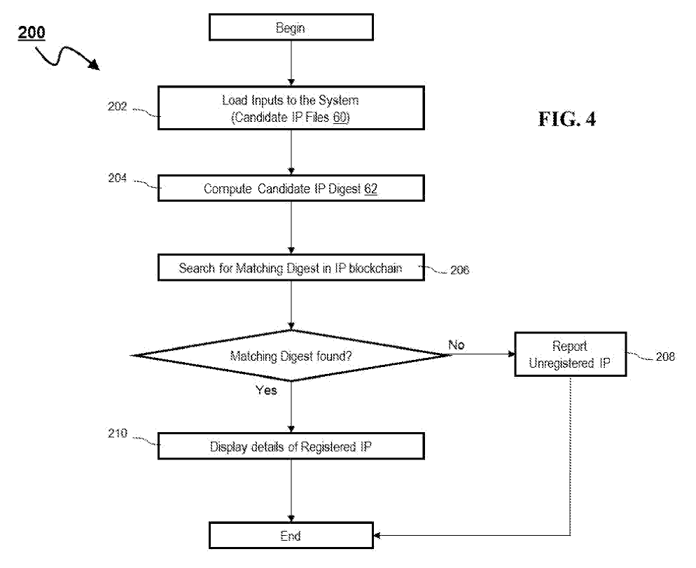

In a first IP verification method 200 as shown in FIG. 4, also known as an IP verification (Type 1) process, an IP file to be verified, namely a candidate IP file 60 is loaded into the controller module 24 in a step 202. In a step 204, a candidate IP digest 62 is computed for the candidate IP file 60 using the same hash function as 46. In a step 206, the computed candidate IP digest 62 of the candidate IP file 60 is then searched for a matching digest within the IP blockchain, for example the updated IP blockchain 58. If no matching digest can be found in the IP blockchain, the IP blockchain system 20 reports an unregistered IP in a step 208 and may prompt the user on whether the IP blockchain system 20 should proceed to store and register the candidate IP digest 62 of this unregistered IP. However, if a matching digest is found, details of the matching digest contained in the IP datablock associated therewith is reported or presented accordingly in a step 210.

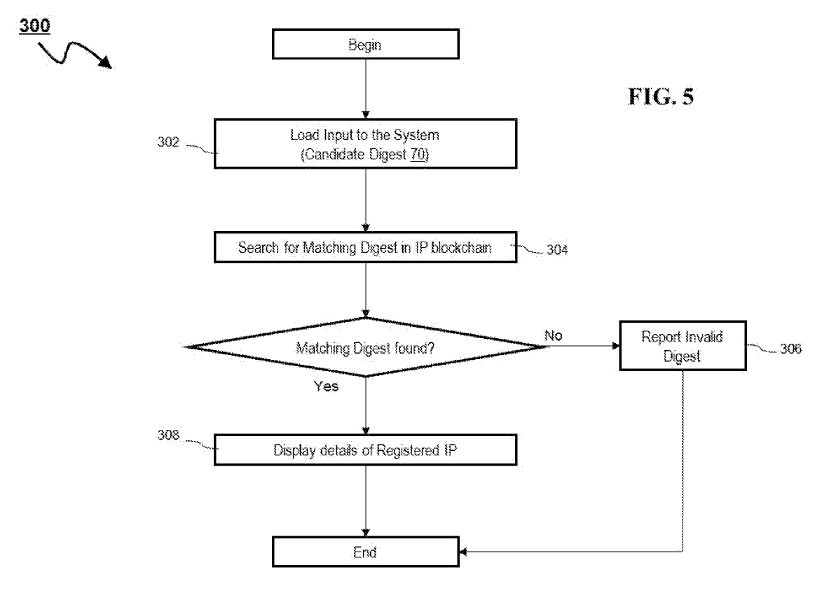

In a second IP verification method 300 as shown in FIG. 5, also known as an IP verification (Type 2) process, a digest to be verified, namely a candidate digest 70 is loaded into the controller module 24 in a step 302. In a step 304, the candidate digest is searched for a matching digest within the IP blockchain 132, for example the updated IP blockchain 58. If there is no matching digest found in the IP blockchain, the IP blockchain system 20 reports an invalid digest in a step 306. However, if a matching digest is found, details of the matching digest contained in the IP datablock associated therewith is reported or presented accordingly in a step 308.

The IP blockchain method 100 is further implementable through a machine-readable medium having stored therein a plurality of programming instructions, which when executed, the instructions cause the machine to process a IP file with a hash function to obtain an IP digest, determine a previous block digest from a previous IP blockchain, and append the previous block digest and IP reference dataset to the IP digest to obtain an IP datablock, the IP reference dataset being associated with the IP file. Wherein the previous IP blockchain is updatable with the obtained IP datablock to obtain an updated IP blockchain.

Aspects of particular embodiments of the present disclosure address at least one aspect, problem, limitation, and/or disadvantage associated with existing computer-implemented methods and systems. While features, aspects, and/or advantages associated with certain embodiments have been described in the disclosure, other embodiments may also exhibit such features, aspects, and/or advantages, and not all embodiments need necessarily exhibit such features, aspects, and/or advantages to fall within the scope of the disclosure. It will be appreciated by a person of ordinary skill in the art that several of the above-disclosed structures, components, or alternatives thereof, can be desirably combined into alternative structures, components, and/or applications. In addition, various modifications, alterations, and/or improvements may be made to various embodiments that are disclosed by a person of ordinary skill in the art within the scope of the present disclosure, which is limited only by the following claims.

1. An Intellectual Property (IP) blockchain method comprising:
processing a IP file with a hash function to obtain an IP digest by a platform system;
determining a previous block digest from a previous IP blockchain by the platform system; and
appending the previous block digest and IP reference dataset to the IP digest to obtain an IP datablock by the platform system, the IP reference dataset being associated with the IP file,
wherein the previous IP blockchain is updatable with the obtained IP datablock to obtain an updated IP blockchain.

2. The method as in claim 1, further comprising:
updating the previous IP blockchain with the obtained IP datablock to obtain the updated IP blockchain.

3. The method as in claim 2, further comprising:
validating the IP datablock against a predefined data structure prior to updating the previous IP blockchain with the obtained IP datablock.

4. The method as in claim 1, the IP reference dataset comprising at least one of:
counter value indicative of ordinal position of the IP datablock amongst a plurality of datablocks constituting the previous IP blockchain;
version number of at least one of protocol and software employed by the platform system for performing the IP blockchain method;
identity of at least one owner of the IP file;
title of the IP file;
at least one of date and time of creation of the IP datablock; and
indication of storage of the IP file in an IP repository.

5. The method as in claim 1, further comprising:
matching the IP datablock with a candidate IP digest for verifying validity of the candidate IP digest.

6. The method as in claim 5, further comprising:
processing a candidate IP file with the hash function to obtain the candidate IP digest.

7. The method as in claim 1, further comprising:
updating a ledger with at least one of the IP datablock and the updated IP blockchain in response to the previous IP blockchain being updated.

8. The method as in claim 1, further comprising:
distributing the updated ledger to a plurality of distributed databases in data communication with the platform system in response to the ledger being updated.

9. The method as in claim 1, further comprising:
encrypting the IP file for storage in an IP repository, the encrypted IP file being associated with the IP datablock.

10. The method as in claim 9, the IP file being encrypted by at least one of private key cryptography, public key cryptography or quantum cryptography.

11. The method as in claim 1, further comprising:
digitally shredding the IP file in response to one of the IP datablock being generated and the updated IP blockchain being obtained.

12. The method as in claim 1, the IP file containing matter relating to at least one of patents, registered designs, trademarks, copyrights, trade secrets, plant breed dataset, electronic masks and documented intellectual assets.

13. The method as in claim 1, the hash function being one of SHA1, SHA256, SHA3, BLAKE and BCRYPT.

14. A machine-readable medium having stored therein a plurality of programming instructions, which when executed, the instructions cause the machine to:
process a IP file with a hash function to obtain an IP digest;
determine a previous block digest from a previous IP blockchain; and
append the previous block digest and IP reference dataset to the IP digest to obtain an IP datablock, the IP reference dataset being associated with the IP file,
wherein the previous IP blockchain is updatable with the obtained IP datablock to obtain an updated IP blockchain.

15. The machine readable medium of claim 14, the plurality of programming instructions when executed, further cause the machine to:
update the previous IP blockchain with the obtained IP datablock to obtain the updated IP blockchain.

16. The machine readable medium of claim 15, the plurality of programming instructions when executed, further cause the machine to:
validate the IP datablock against a predefined data structure prior to updating the previous IP blockchain with the obtained IP datablock.

17. The machine readable medium of claim 14, the IP reference dataset comprising at least one of:
counter value indicative of ordinal position of the IP datablock amongst a plurality of datablocks constituting the previous IP blockchain;
version number of at least one of protocol and software employed by the machine;
identity of at least one owner of the IP file;
title of the IP file;
at least one of date and time of creation of the IP datablock; and
indication of storage of the IP file in an IP repository.

18. The machine readable medium of claim 14, the plurality of programming instructions when executed, further cause the machine to:
match the IP datablock with a candidate IP digest for verifying validity of the candidate IP digest.

19. The machine readable medium of claim 14, the plurality of programming instructions when executed, further cause the machine to:
process a digital IP file with the hash function to obtain the candidate IP digest.

20. The machine readable medium of claim 14, the plurality of programming instructions when executed, further cause the machine to:
update a ledger with at least one of the IP datablock and the updated IP blockchain in response to the previous IP blockchain being updated; and
distribute the updated ledger to a plurality of distributed databases in data communication with the platform system in response to the ledger being updated.

21. The machine readable medium of claim 14, the plurality of programming instructions when executed, further cause the machine to:
encrypt the IP file for storage in an IP repository, the encrypted IP file being associated with the IP datablock, and the IP file being encrypted by at least one of private key cryptography, public key cryptography or quantum cryptography.

22. The machine readable medium of claim 14, the plurality of programming instructions when executed, further cause the machine to:
digitally shred the IP file in response to one of the IP datablock being generated and the updated IP blockchain being obtained.

23. The machine readable medium of claim 14, the IP file containing matter relating to at least one of patents, registered designs, trademarks, copyrights, trade secrets, plant breed dataset, electronic masks and documented intellectual assets.

24. The machine readable medium of claim 14, the hash function being one of SHA1, SHA256, SHA3, BLAKE and BCRYPT.

25. An Intellectual Property (IP) blockchain system comprising:
a first database module for providing an IP file to be processed;
a second database module for providing auxiliary information dataset associated with the IP file, the auxiliary information dataset comprising identity of at least one owner of the IP file and title of the IP file;
a third database module for providing a previous IP blockchain; and
a controller module in data communication with the first database module, the second database module and a third database module, the controller module for:
processing the IP file with a hash function to obtain an IP digest;
determining a previous block digest from the previous IP blockchain;
appending the previous block digest and an IP reference dataset to the IP digest to obtain an IP datablock; and
updating the previous IP blockchain of the first database module with the obtained IP datablock,
wherein the IP reference dataset comprises at least one of counter value indicative of ordinal position of the IP datablock amongst a plurality of datablocks constituting the previous IP blockchain, version number of at least one of protocol and software employed by the platform system for performing the IP blockchain method, at least one of date and time of creation of the IP datablock, indication of storage of the IP file in an IP repository, the identity of at least one owner of the IP file, and the title of the IP file.
